(19) United States
(12) Patent Application Publication
(10) Pub. No.: US 2012/0282921 A1
(43) Pub. Date: Nov. 8, 2012

(54) FREE WI-FI

(76) Inventors: Iftah MOTOLA, Herzliya (IL); Revital Agami, Givatayim (IL)

(21) Appl. No.: 13/098,499

(22) Filed: May 2, 2011

(51) Int. Cl. H04W 80/04

(52) U.S. Cl. 455/426.1

(57) ABSTRACT

A system and method for providing access to readily available wireless Internet access by sending an SMS message to a number related to a wireless signal provider and receiving a temporary access code therefrom, for accessing the wireless signal.

### FIELD AND BACKGROUND OF THE INVENTION

The present invention relates to a method and system for providing readily available wireless internet and, more particularly, to a system and method for providing wireless internet access in response to an SMS request.

In recent years the phenomenon of a “Wi-Fi hotspot”, where wireless Internet service is provided at a cost or for free, has become widespread. The hotspot serves a useful purpose of providing Internet access for transient users at strategic locations, but is limited to relatively few areas, such as airports, coffee shops and the like. But, if there is no hotspot there is no readily available Internet access.

The ubiquitous use of cell-phones, and in particular smart phones, has led to a further phenomenon of accessing the Internet wireless cellular connectivity. Cellular Internet surfing has become a boon for the cellular communications providers, enabling the companies to charge a first rate for cellular telecommunications and an additional rate for wireless Internet access. For the user, this presents a number of drawbacks: firstly the additional cost over and above the cost for the cellphone calls as well as, usually, a built in cost for the (oft expensive) handset itself. Furthermore, the data consumption is generally limited, incurring an even higher rate when the user inadvertently goes over the limit (a relatively common occurrence as most users are not aware of the data consumption and how close they are to their usage limit).

Additionally, many laptop users currently make use of USB cellular dongles which provide cellular Internet connectivity to the laptops. It is common to find laptop users in public areas (parks, plazas, etc.) where there are no WIFI hotspots, but the laptop users are able to connect to the Internet, for purposes of business or pleasure, via the cellular dongles (or even built-in cellular transceivers—in newer laptop models). The cellular connectivity gives the users great freedom in choosing a place to work or relax while using the Internet. The cellular providers have once again found an avenue to charge users additional fees for both purchasing the cellular dongle and data consumption.

It would be highly advantageous to many laptop and smart phone users to have readily available wireless connectivity (referred to hereinafter as “Wi-Fi”) in diverse areas for free or at a nominal price, without having to invest in expensive payment/usage plans or purchase additional devices.

### DEFINITIONS

The term ‘wireless signal’ is user herein to refer to a wireless local area network (WLAN) broadcast signal which provides a wireless connection through an access point to the wider Internet. A wireless access point (WAP), which broadcasts the wireless signal, is connected to a wired access point such as a DSL modern which is connected to an Internet Service Provider (ISP) which, in turn, provides a connection to the World Wide Web (Internet).

The term ‘Wi-Fi’ is used herein to broadly refer to the technologies that use a wireless signal.

In the context of the disclosure the term ‘mobile device’ is used to refer to cell-phones, smart phones, laptops, tablets, iPads and any other mobile devices that have Wi-Fi capabilities.

The term ‘mobile cellular device’ refers to a mobile device that is able to access a cellular network and more specifically send and receive Short Message Service (SMS) messages.

The system and application described in detail below may be embodied on hardware, firmware, software or any combination thereof.

### SUMMARY OF THE INVENTION

The current innovative system provides Internet access via Wi-Fi free of charge by sending a text message and receiving a user code for accessing the wireless Internet connection free of charge.

According to the present invention there is provided a method of providing access to wireless Internet access, the method including the steps, by a server, of: (a) registering a Wireless Access Point (WAP), the WAP having an Internet Protocol (IP) address; (b) assigning a cell-phone number to the IP address; (c) receiving a Short Message Service (SMS) request message, sent to the cell-phone number assigned to the IP address from a user mobile cellular device located in range of a wireless signal broadcast from the said WAP, the SMS request message including a request for a limited access code to the wireless signal; (d) sending an SMS code message including a limited access code to the user mobile cellular device; (e) granting limited access to the wireless signal to a mobile device that is providing the limited access code to the server, when the mobile device is located in range of the wireless signal. According to further features in preferred embodiments of the invention described below, the sending of said SMS code message is dependant on availability of the wireless signal, where the availability is dependant on elements including: (i) availability of at least a predetermined amount of unused bandwidth; and (ii) predetermined times of a day.

According to still further features in the described preferred embodiments the granting of limited access to the wireless signal is dependant on the limited access code being valid.

According to still further features the limited access is selected from the group including: a predetermined amount of time, a predetermined amount of bandwidth, a predetermined amount of data.

According to still further features the method further includes the step of (f) sending an SMS warning message, to the user mobile cellular device, when the access limit is close to being reached, the warning message including a message alerting a user of the user mobile cellular device that the access limit is close to being reached.

According to still further features the method further includes the step of: (g) sending at least one additional SMS code message, to the user mobile cellular device, in response to receiving at least one additional SMS request message.

According to still further features the method further includes the step of: (g) sending at least one SMS extension message, to the user mobile cellular device, in response to receiving at least one additional SMS request message, where the at least one SMS extension message including extension information.

According to the present invention there is provided a system for providing access to Internet access, the system including: (a) a server for managing the system; (b) at least one registered Wireless Access Point (WAP) for broadcasting a wireless signal, wherein each WAP has an Internet Protocol (IP) address and wherein each WAP is registered with the server and wherein the server assigns a cell-phone number to each IP address; (c) a cellular component for receiving a Short Message Service (SMS) request message sent to each cell-phone number, requesting a limited access code and sending an SMS code message, including a limited access code, received from the server.

According to further features in preferred embodiments of the invention the system further includes: (d) a computer-readable cellular application (app) embodied on a computer-readable medium, for: (i) automatically detecting a said cell-phone number assigned to a said IP address of a said registered WAP and (ii) sending a said SMS request message to a said cell-phone number assigned to said IP address of a said registered WAP, requesting a said limited access code.

According to still further features the computer-readable medium is a nonvolatile memory included in the server.

According to still further features the computer-readable cellular application is configured to be downloadable from the server to a user mobile device, via a website.

According to still further features the WAP is selected from the group including: a wireless router and a wireless repeater.

According to the present invention there is provided a business method for providing access to a wireless signal in return for sending an SMS message, the method including the steps, by a server, of: (a) registering a Wireless Access Point (WAP), the WAP having an Internet Protocol (IP) address; (b) assigning a cell-phone number to the IP address; (c) receiving a Short Message Service (SMS) request message, sent to the cell-phone number assigned to the IP address from a user mobile cellular device located in range of the wireless signal broadcast from the WAP, the SMS request message including a request for a limited access code to the wireless signal; (d) sending an SMS code message, including a limited access code, to the user mobile cellular device; and (e) granting limited access to the wireless signal, to a mobile device that is providing a limited access code to the server, when the mobile device is located in range of the wireless signal.

According to further features in preferred embodiments of the invention the WAP is managed by a WAP controller.

According to still further features the WAP controller is compensated for broadcasting the wireless signal.

According to still further features the compensation is a predetermined percentage of a cost of sending the SMS request message.

According to still further features the server is managed by a managing entity selected from the group including: an Internet Service Provider (ISP) and a service center.

According to still further features the managing entity receives a percentage of the cost of sending the SMS request message.

According to still further features, an advertizing entity pays for said SMS request message.

According to still further features, the limited access includes advertizing information.

### BRIEF DESCRIPTION OF THE DRAWINGS

Various embodiments are herein described, by way of example only, with reference to the accompanying drawings, wherein:

FIG. 1 is a schematic overview of an embodiment of the invention;

FIG. 2 depicts a progression of screenshots of another embodiment of the invention, including a cellular application;

FIG. 3 depicts a flow chart of the invention including some preferred embodiments.

FIG. 4 is a schematic overview of a further embodiment of the invention;

FIG. 5 is a high-level block diagram of a server of a preferred embodiment of the invention.

### DESCRIPTION OF THE PREFERRED EMBODIMENTS

The principles and operation of a method for providing access to readily available wireless Internet access according to the present invention may be better understood with reference to the drawings and the accompanying description.

System

Server

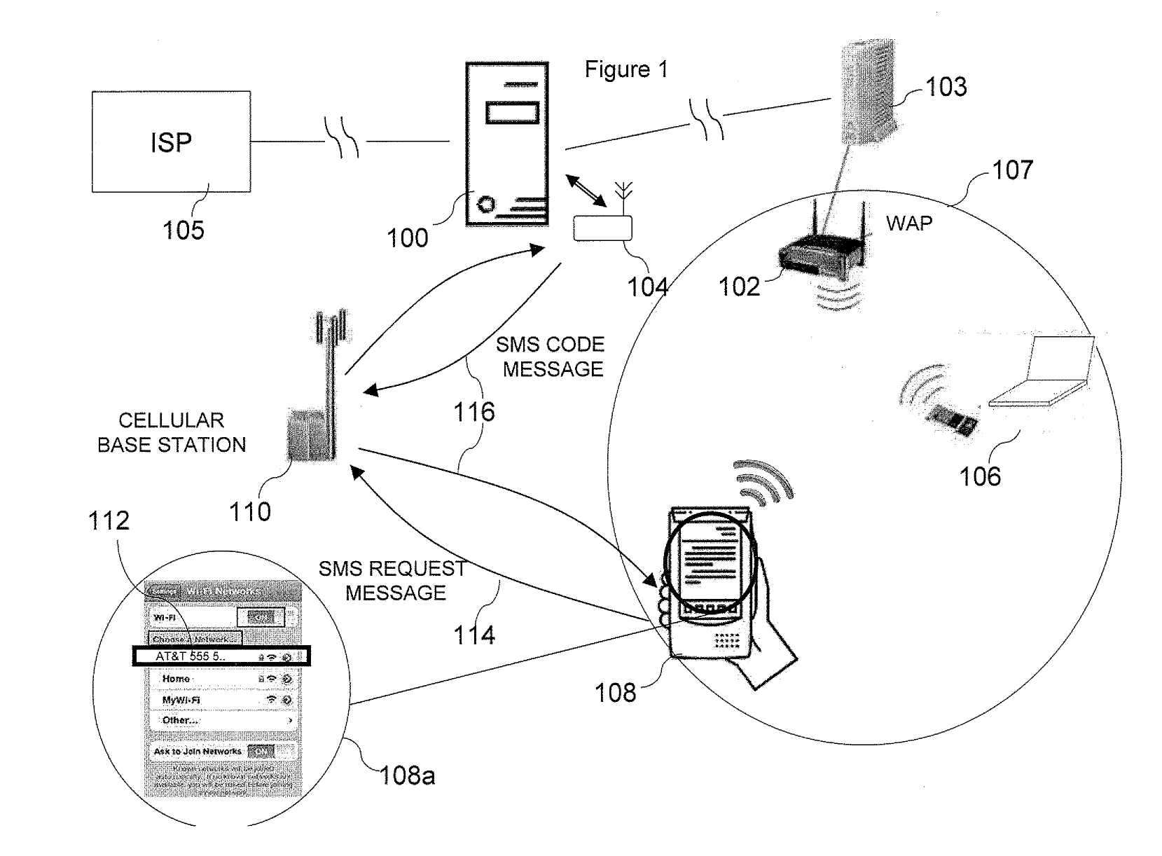

Referring now to the drawings, FIG. 1 illustrates a schematic overview of a preferred embodiment of the innovative system. The system includes a server 100 that manages the system. In some embodiments of the invention users as well as wireless signal providers register on the server. In other embodiments, only wireless signal providers need to register, but users do not need to register. Signal providers are Wireless Access Points (WAPs) 102, usually wireless routers, repeaters or similar devices that broadcast wireless signals. A WAP is generally connected in a wired manner to cable/DSL/ADSL modem 103 which provides the Internet access. Each modem 103 is assigned an Internet Protocol (IP) address. WAP 102 is linked or connected to the IP address. In FIG. 1 the server 100 is interposed between the Internet Service Provider (ISP) 105 and modem 103. This configuration is merely exemplary as there are numerous possible configurations, some of which are mentioned explicitly further on herein. Individuals or companies register signal providers with the system to provide a wireless signals to system users. Users are individuals who wish to access the wireless signal with a mobile device. In some embodiments of the invention, both the providers and users must agree to the Terms of Use at the time of registration, in order for all financial ramifications stemming from wireless provision and usage to be legally binding. In other embodiments where users do not register, the user must be informed of the financial ramifications for the provided service, before access is granted.

WAP

Each WAP 102 is linked to an Internet Protocol (IP) address. Potentially, a number of WAPs 102 may be linked to the same IP address. In addition, the server assigns a cellular phone number to the IP address. This number may be a unique cell-phone number, or a generic cell-phone number, belonging, for example, to the ISP servicing that IP address. SMS request messages are sent to this cell-phone number and SMS code messages are sent from this number. The system includes a cellular component 104 to handle the SMS message traffic. Potentially, signal providers agree to allot up to a predetermined portion of their WLAN bandwidth for use by potential users. The system coordinates between the registered providers and Internet Service Providers (ISP). Potentially, the ISP can provide the service directly. Alternatively a third party can provide the service from a service center. Further alternatively, the WAP controller can provide the service directly. The WAP broadcasts a wireless signal within given range 107. Potential users within range of the broadcast signal are able to detect the signal. The user is a mobile device such as a laptop 106 (depicted in FIG. 1 with a wireless adapter card) with Wi-Fi capabilities or a smartphone 108 with similar capabilities. Mobile devices have built-it signal detectors. An exemplary screenshot of an iPhone™ Wi-Fi Finder screen 108a is depicted in the magnified area. A wireless signal is usually identified by a name (e.g. the name of the ISP) and the strength of the signal is also displayed. In the innovative system, the displayed signal details include the assigned cell-phone number 112 (in some embodiments, the number may be in place of the name). In the exemplary depiction, cell-phone number 555 555 5555 is partially visible in enlarged area 108a as is the name “AT&T” which is a well known service provider in the US. A user wishing to access the signal sends an SMS request message 114 to the assigned number 112, requesting a temporary or otherwise limited access code. The SMS messages are routed via a cellular base station 110, as is well known in the art. (The base station is merely exemplary and is depicted in the figure primarily to differentiate between the cellular network for transmitting SMS messages and the wireless network for providing a wireless signal and access to the Internet.) In the presently depicted embodiment, cellular component 104 interfaces with server 100. The server logs the requests and checks that the user requesting the access code is registered with the system. If the user is registered then an access code 116 is sent to the user (via cellular component 104). If the user is not registered then the server sends an SMS registration message offering the user to register on the system or to at least agree to a Term of Use clause which makes financial obligations legally binding. The tariff for SMS messages may be included in the SMS registration message. Once the user registers (or agrees to the Terms of Use), the server can send the access code to the user in a SMS code message. In some embodiments discussed below, a user registers by downloading a mobile application (app) and agreeing to the Terms of Use clause, whereby the user is registered on the system. It is clear that the phrase ‘Terms of Use clause’ is only exemplary and is intended to include any legally binding arrangement, even if the arrangement is presented in a forma or manner.

Cellular Component/SMS Messages

Users send SMS request messages 114 via a cellular base station 110 to cellular component 104. A user wishing to gain access to a wireless signal must send an SMS request message 114 to the cell-phone number 112 assigned to the IP address of WAP 102. The SMS request message is sent by a user and includes a request for a temporary/limited access code. The cellular component 104 receives the message and interfaces with the server 100 as described above. If the user request is approved then cellular component 104 sends an SMS code message 116 back to the user. SMS code messages include a code which, when entered, provides the user temporary/limited access to the wireless signal and Internet access. Granting permission and sending a temporary code may be done automatically, semi-automatically or manually. Once the code is received via SMS, the user enters the code on a mobile device (e.g. smartphone, laptop). The code may be received on a mobile cellular device (e.g. smartphone) and entered on a different mobile device (e.g. a laptop). If the access code is valid, the device is granted access for a predetermined amount of time.

In some embodiments, the access code may only grant access to a mobile cellular device. In other embodiments the access code may grant access to both the mobile cellular device receiving the code as well as a second mobile device, such as a laptop. In still other embodiments, the access code may only grant access to a second mobile device, but not to the mobile cellular device that received the SMS code message. A single access code may provide access to multiple devices (i.e. more than two). Additional configurations or the type of access granted by the access codes, as would be obvious to one skilled in the art, are included in the scope of this disclosure.

In some embodiments of the system, when the allotted time is nearly finished, server 100 sends an SMS message alerting the user to the impending termination of access to the wireless signal. In other embodiments, a cellular application (app), described in greater detail below, prompts the user to send another SMS request message. A user, wishing to continue using the wireless signal sends a further SMS request message 114. In one embodiment, cellular component 104 sends a new code to be entered as before. In an alternative embodiment, the cellular component 104 sends a mere confirmation message informing the user as to how much additional time has been allotted on the same access code. In the latter embodiment, the SMS request message is an SMS extension request message, potentially with an exemplary message such as “Would you like to continue surfing?”, to which the user need only send a reply message such as “Yes”.

In some embodiments of the invention, the SMS code message contains two temporary codes, either of which can be entered but not both. One code grants access as previously described. The second code grants access to the wireless signal with no charge for the SMS request message, or no additional charge above the base rate, or for a reduced charge for the SMS request messages. The second code also allows access to the WLAN, similar to the first code, except that with the second code any activity (e.g. Internet browsing, email etc.) is “branded” with advertizing information. In some embodiments the advertizing information is only/also displayed to the user during access. The advertizing information relates to the controller of the WAP, or, potentially, to any other entity involved, such as the ISP, service center or even a third party entity. In fact anybody can advertise, as long as they are willing to foot the bill. The following examples will help clarify the various embodiments: Example 1—a Coffee Shop has a registered WAP providing a wireless signal to patrons of the establishment. A user inputs the second code, which grants “branded” access, but no charge or reduced charge for the SMS request message. Any emails sent by the user will be branded with the Coffee Shop logo and sentence along the lines of “This email was sent while relaxing at the Coffee Shop”.

The standard duration of the temporary access as well as the fee for the SMS message and the percentage of the fee which is given to the provider are all determined and agreed upon before or at the time of registration. Various potential financial packages are discussed below.

Cellular Application (App)

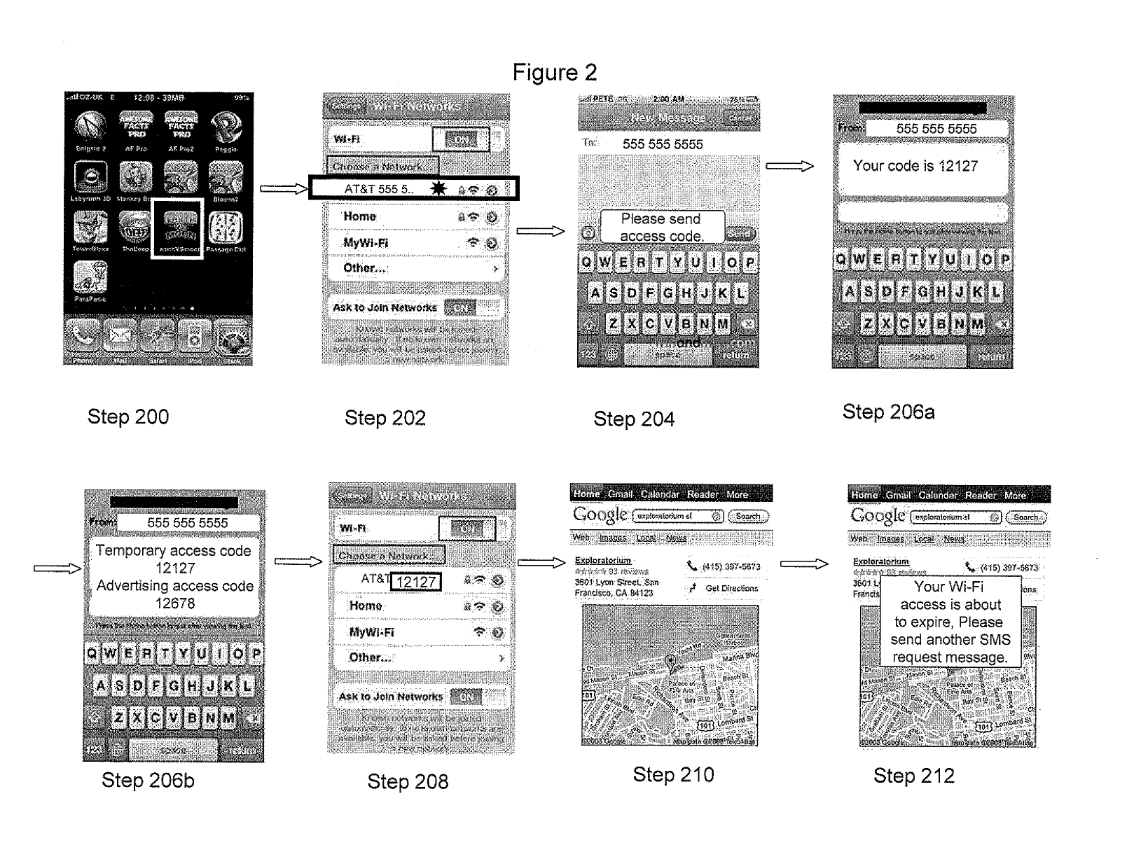

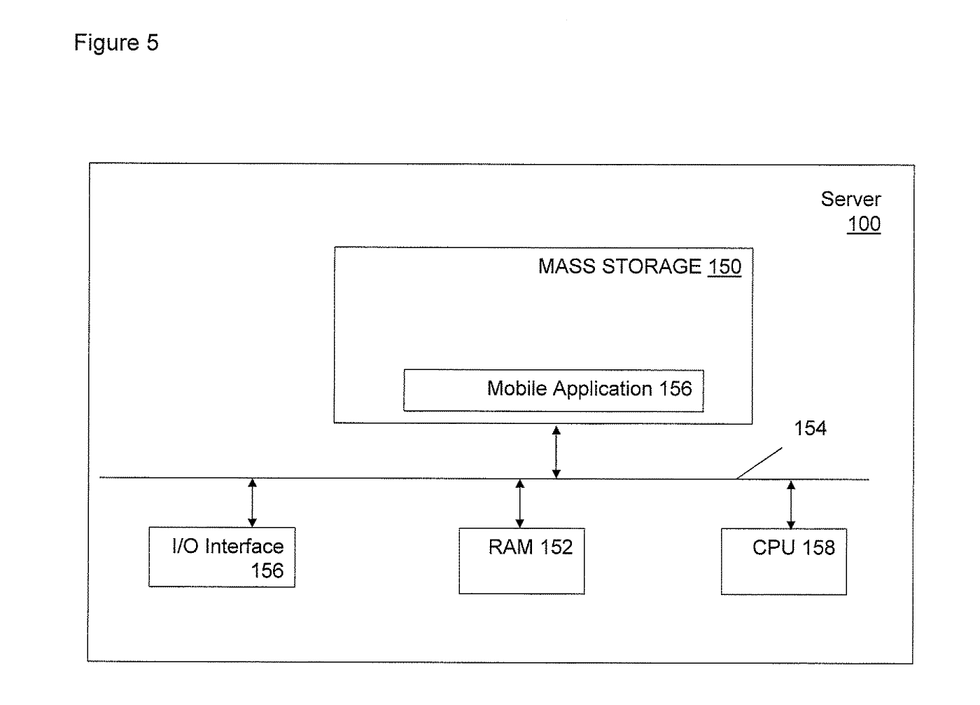

Referring to FIG. 2, the Figure depicts a preferred embodiment of the invention, including a cellular application. FIG. 2 depicts screen captures from an iPhone™ mobile cellular device running the app. In some embodiments of the system, a user can download and install a cellular application (app) from server 100 onto a mobile cellular device and agree to the Terms of Use for using the system (step 200). Of course the app may be downloaded from an affiliated website, although, as depicted in FIG. 5 below, the app is stored on nonvolatile memory in the server. Generally, the Terms of Use will provide the user with details relating to the modified or unmodified cost of sending an SMS request message. By downloading the app and agreeing to the Terms of Use, the user automatically get registered on the system. The mobile cellular device is capable of detecting available wireless signals. The downloaded app enhances the detection function by identifying signals from registered signal providers as well as the assigned cellular number (step 202). Once a signal from a registered WAP is selected and confirmed, the app (automatically, semi-automatically or manually) sends an SMS request message to the assigned cellular number (e.g. “555 555 5555” in the Figure), requesting a temporary access code (step 204). When the request is approved, an SMS code message is sent, including a temporary code (step 206a). In an alternative embodiment, two codes are sent is detailed above (step 206b). The code can be entered in the wireless signal detection screen (step 208). Conditional access is granted in accordance with the selected code (step 210). In the depicted embodiment, the app alerts the user that the limited access is soon to expire if no action is taken (step 212). The user will either go back to step 204 and request a further code or extension of the current code, or the user will be denied access to the wireless signal then the temporary code expires. It is hereby made clear that the depiction of mobile app in use on an iPhone™ is merely exemplary and that applications similar in function but intended for other mobile devices, including laptops, are included in the scope of the invention.

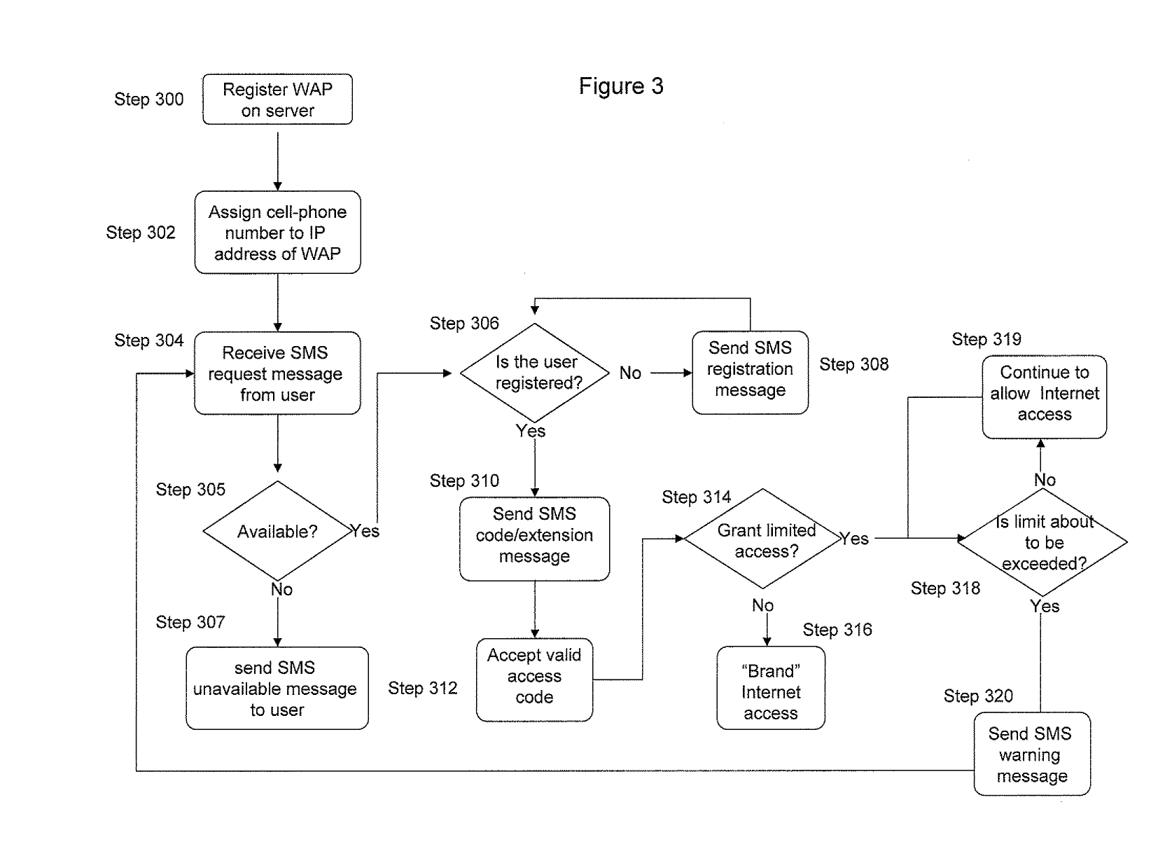

FIG. 3 depicts a flow chart of the invention including some preferred embodiments.

Step 300

A WAP, linked to an IP address, is registered on the server.

Step 302

The server assigns a cell-phone number to the IP addressed to which the WAP is linked. Potentially, more than one WAP can be linked to a single IP address.

Step 304

The cellular component of the system receives an SMS request message from a mobile cellular device which is located in range of the wireless signal broadcast by the registered WAP.

Step 305

The system checks if the registered WAP is available. The WAP may not be available due to any number of factors including, for example: other users are currently using the predetermined quota of bandwidth allotted for user use; the WAP controller has agreed to make the wireless signal available to the public only at predetermined times; the WAP controller has requested that no users be granted access at the desired time. If the WAP is available go to Step 306. If the WAP is not available, go to Step 307

Step 307

Send an SMS ‘unavailable’ message to the user requesting access to the wireless signal.

Step 306

The system checks the server to ascertain whether the mobile cellular device that sent the SMS request message is registered with the system. If the mobile cellular device is registered, or has otherwise agreed to the financial/legal obligations, go to Step 310, otherwise go to step 308

Step 308

The system sends an SMS registration message from the cellular component, the message includes registration instructions for the user. In some embodiments of the invention, the cellular app must be downloaded and installed and the Terms of Use clause must be agreed to. In other embodiments, the user can register over the Internet. This can potentially be achieved using a mobile cellular device that is able to access the Internet. In still further embodiments, where no user registration is necessary, the message includes a disclaimer or Terms of Use clause which details the financial/legal obligations. The user agrees to the terms of the obligation by sending a response SMS. Go to Step 306.

Step 310

The system sends an SMS code message to the sender of the SMS request message. In some embodiments of the invention, the code message includes a limited access code. In other embodiments, the code message includes two codes, one code is a limited access code and the other code is an unlimited access code which allows “branded” access to the Internet as explained above. If the request message was an extension request message, then the SMS message sent in this step is an SMS extension message which includes extension information, such as the additional duration of access granted to the user.

Step 312

The mobile device provides the limited access code to the system. In the embodiments of the invention which include the app, the code is entered in the space provided by the app, potentially on the Wi-Fi Finder screen on the app. In embodiments of the invention which do not include the app, the access code is entered in the provided space on an entry page to which the Internet browsing software is redirected. This type of entry page is well known in the art. In all of the embodiments, the system receives the access code and accepts valid codes or rejects invalid or expired codes.

Step 314

If the received code is a limited access code then proceed to Step 318, otherwise go to Step 316.

Step 316

In response to receiving an access code allowing “branded” access, all Internet activity is “branded” with advertizing material.

Step 318

After granting limited access to the user, the server constantly checks whether the allotted time period has elapsed. In some embodiments of the invention, the limited access code may grant access which is limited in other ways than time. Potentially, access may be limited to the amount of data downloaded. In all embodiments, if the limitation has not been exceeded then access continues to be granted in Step 319. In some embodiments of the invention, the system provides a warning to the user when the access limit is being approached in step 320. In other embodiments, the app provides this warning.

Step 319

Access is granted, go to step 318.

Step 320

When the limit is close to being exceeded, the server sends an SMS warning message to the user, warning the user of the impending termination of access unless an extension request or additional access code is entered. If user sends an additional request message (potentially in the form of a response message “Yes” to the warning message “Your access is about to be terminated, would you like to continue?”), go to Step 304.

Alternative Configurations

In some embodiments (not depicted), the cellular component 104 and/or server 100 reside within the ISP. In other embodiments (not depicted) cellular component 104 and/or server 100 reside in a service center which interfaces between the ISP 105 and the WAP 102. In still other embodiments (not depicted), the cellular component is a cell-phone controlled by the controller of the WAP 102. Potentially any applicable combinations of the aforementioned configurations are also included in the scope of this disclosure.

Financial Arrangements

Various financial packages are envisioned, to optimally realize the current innovative system. Today, cell-phone users who are able to send and received SMS message generally have two types of payment structures: 1. payment per SMS message sent from the mobile cellular device or 2. a flat rate for SMS messages. Again, the flat rate may be for unlimited messages or limited messages. In the latter case if a user exceeds the limit there is generally an inflated rate charged per message exceeding the limit. Of course there may exist slight variations to these aforementioned rules.

A number of financial options are envisioned: Option 1: The SMS fee is built from a base fee and an additional service fee. This service fee is “payment” for the use of the system. No fee is charged for the Wi-Fi service per se. With the two code option mentioned above, choosing the “branded” option, the advertizing entity pays the service fee, leaving the user with only the base SMS fee.

Option 2: The service is provided for a base fee only. The ISP has an agreement with the cellular provider to split the revenue for the base fee. This arrangement is for a regular code. For a “branded” code, the advertizing entity pays the base fee itself, and the user enjoys Wi-Fi free of charge and even without charge for the SMS messages.

The other part of the financial arrangement is the compensation to the WAP controller. The WAP controller needs an incentive to provide the wireless signal. In Option 1 mentioned above, the base fee for the SMS goes to the cellular provider. The service fee is divided up between the ISP and the WAP controller. With the “branded” code, the advertizing entity pays the service fee to the ISP and WAP controller. If the advertizing entity is either the ISP or the WAP controller, then only portion of the service fee is paid to the non-advertizing entity.

In Option 2, the user only pays the base fee for the SMS message. A first portion of the fee goes to the cellular provider, a second portion goes to the ISP and a third portion goes to the WAP controller. With the “branded” code, the advertizing entity pays the base fee in place of the user. If the advertizing entity is one of the three entities that receive a portion of the base fee, then the advertizing entity must only pay the remaining non-advertizing entities' portion.

Potentially, if the managing entity of the system is a third party running the service center, the payment may be further divided to apportion a percentage to the service center, a portion to the WAP controller and a portion to the ISP.

Although payment for services has been mentioned explicitly, other forms of remuneration are envisioned. In one alternative, the ISP can provide Internet service to the WAP controller at a reduced rate, as a form of remuneration for broadcasting the wireless signal.

In a non-limiting exemplary scenario, an SMS request message has a cost of X+Y. X is the base fee awarded to the cellular provider for the SMS service. Y is the service fee for the system. 65% of Y goes to the ISP and 35% goes to the WAP controller. If the user makes use of the “branded” code and the ISP is the advertizing entity, then the user will only pay the base fee and the ISP will pay 35% of Y to the WAP controller.

Of course, the cellular provider can build the fee into a payment plan or some other similar arrangement. Furthermore, the ISP can adjust the payment plan of the WAP controller in order to compensate for managing the bandwidth to accommodate system users. The aforementioned financial arrangements are exemplary and not intended to limit the scope of the invention, as other financial arrangements that would be obvious to those skilled in the art are also included herein.

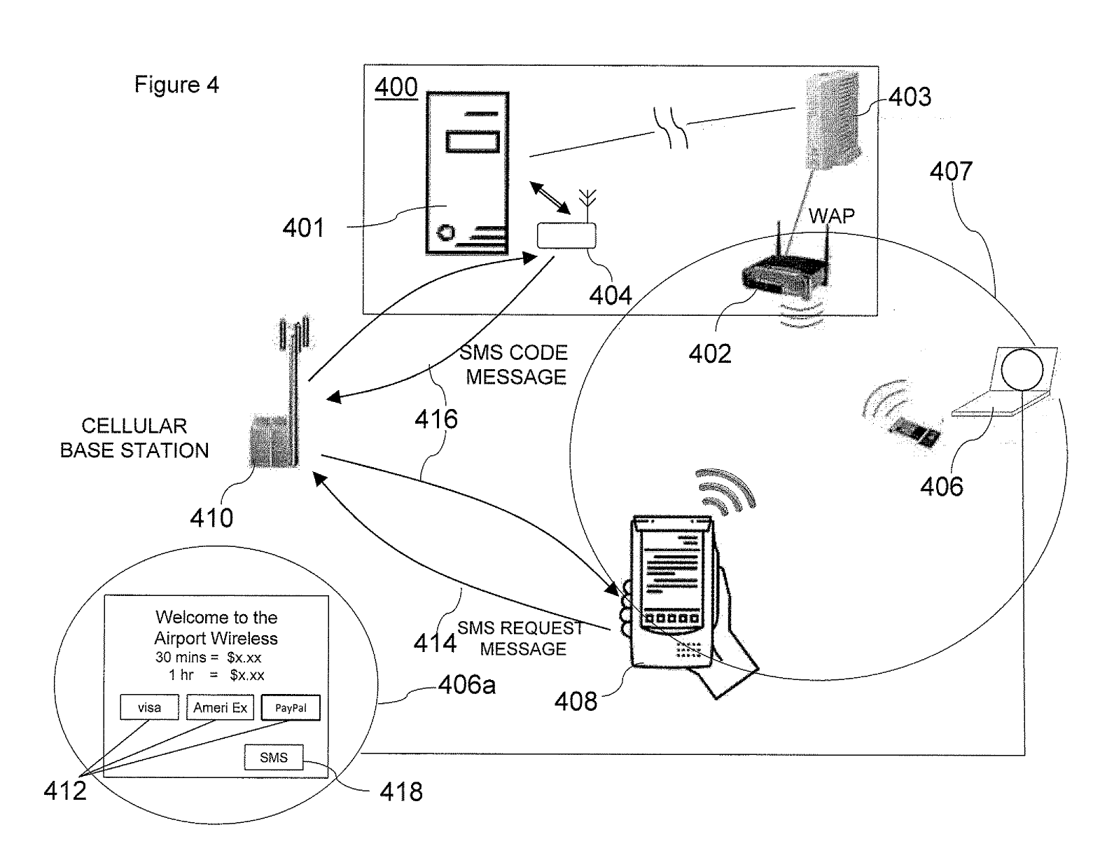

Another possible configuration is shown in FIG. 4. System 400 includes a server 401, cellular component 404, modem 403 and at least one WAP 402. Modem 403 is connected to the Internet. At least one WAP 402 is connected to modem 403 either directly or through intermediary device known in the art. Server 401 controls and manages all requests for access to the wireless signal broadcast by the WAP(s) 402. The current configuration is intended, primarily, to provide an additional mode of payment for Internet access at a ‘hot spot’. Exemplarily, in modern airports around the world, a traveler can access the Internet for a fee. Of course, while any ‘hot spot’ that charges a fee for access to the Internet, such as a hotel, café, etc., can employ the system, for the sake of clarity, the example of an airport is described hereafter. The traveler, using a laptop 406 with Wi-Fi capabilities, opens a browser and is redirected to an entry page 406a. The entry page gives details of tariffs for units of time, X Dollars for 30 minutes, Y Dollars for an hour etc. On the page are payment methods such as credit card or payment service (e.g. PayPal™, iPass™) 412. The traveler selects a payments method and provides details, and, in some cases, selects the desired unit of time for access. The current innovative system offers an improved feature allowing a traveler (in the current exemplary scenario) to send an SMS message as a method of payment. Exemplarily, one SMS message grants 15 minutes access, a second message grants and additional 15 minutes access etc. The entry page includes an SMS button 418. In one potential embodiment, when the SMS button is pressed, a number for SMS messages appears with instructions to send an SMS request message 414 and a space is provided for entering the code. The SMS request message 414 is sent from mobile cellular device 408 via a cellular base station 410 to the cellular component 404 of the system. In response to the SMS request message 414, the system 400 will send an SMS code message 416. Potentially, the SMS code is generated by the server 401 and sent from cellular component 404 back to the mobile cellular device 408. The traveler or user must enter the code on the entry page, in the designated area. The system 400 receives the code and allows access to the wireless signal based on validation of the code. Additional request messages can be sent in order to receive additional codes or extended time on the same code. Further potentially, the system may offer two codes, one with limited access and the other with unlimited access but with “branded” browsing, as detailed above. The system is equally suited and intended for other mobile devices such as, but not limited to, a smartphone 408, iPad™ or any other mobile device with Wi-Fi capabilities.

Even though many variations of how the system recognizes the mobile device that is related to the mobile cellular device sending the SMS request messages are obvious to those skilled in the art, only the most preferred method and system have been described above. Furthermore, a mobile app is envisioned which automates or partially automates the process of finding a hotspot, discovering the cell-phone number to which the SMS messages must be sent, sending the SMS request messages (after user confirmation) and alerting the user when the time limit approaches.

FIG. 5 is a high-level block diagram of a server 100 of a preferred embodiment of the invention. Server 100 includes a mass storage component 150 such as a hard drive or any other non-volatile memory/storage medium. CPU 158 can load the application into Ram 152, should there be a need to run the app on the server, although, primarily, the Mobile Application 156 is simply stored in mass storage 150 to be downloaded on demand via Input/Output Interface 156. All the components of Server 100 communicate with each other via bus 154. It is clear that FIG. 5 only partially represents the components and elements found in server 100, particularly those which pertain to mobile application 156. When the mobile application is downloaded onto a user mobile device, via methods known in the art, the CPU/OS of the mobile device installs the application, so that it may be used.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method of providing access to wireless Internet access, the method comprising the steps, by a server, of:
(a) registering a Wireless Access Point (WAP), said WAP having an Internet Protocol (IP) address;
(b) assigning a cell-phone number to said IP address;
(c) receiving a Short Message Service (SMS) request message, sent to said cell-phone number assigned to said IP address from a user mobile cellular device located in range of a wireless signal broadcast from said WAP, said SMS request message including a request for a limited access code to said wireless signal;
(d) sending an SMS code message including a said limited access code to said user mobile cellular device;
(e) granting limited access to said wireless signal to a mobile device that is providing said limited access code to the server, when said mobile device is located in range of said wireless signal.

2. The method of claim 1, wherein said sending of said SMS code message is dependant on availability of said wireless signal.

3. The method of claim 2, wherein said availability is dependant on elements including:
(i) availability of at least a predetermined amount of unused bandwidth; and
(ii) predetermined times of a day.

4. The method of claim 1, wherein said granting limited access to said wireless signal is dependant on said limited access code being valid.

5. The method of claim 1, wherein said limited access is selected from the group including: a predetermined amount of time, a predetermined amount of bandwidth, a predetermined amount of data.

6. The method of claim 1, further comprising the step of:
(f) sending an SMS warning message, to said user mobile cellular device, when said access limit is close to being reached, said warning message including a message alerting a user of said user mobile cellular device that said access limit is close to being reached.

7. The method of claim 6, further comprising the step of:
(g) sending at least one additional said SMS code message, to said user mobile cellular device, in response to receiving at least one additional said SMS request message.

8. The method of claim 6, further comprising the step of
(g) sending at least one SMS extension message, to said user mobile cellular device, in response to receiving at least one additional said SMS request message, said at least one SMS extension message including extension information.

9. A system for providing access to Internet access, the system comprising:
(a) a server for managing the system;
(b) at least one registered Wireless Access Point (WAP) for broadcasting a wireless signal, wherein each said WAP has an Internet Protocol (IP) address and wherein each said WAP is registered with said server and wherein said server assigns a cell-phone number to each said IP address;
(c) a cellular component for receiving a Short Message Service (SMS) request message sent to each said cell-phone number, requesting a limited access code and sending an SMS code message, including a said limited access code, received from said server.

10. The system of claim 9, further comprising:
(d) a computer-readable cellular application (app) embodied on a computer-readable medium, for: (i) automatically detecting a said cell-phone number assigned to a said IP address of a said registered WAP and (ii) sending a said SMS request message to a said cell-phone number assigned to said IP address of a said registered WAP, requesting a said limited access code.

11. The system of claim 10, wherein said computer-readable medium is a nonvolatile memory included in said server.

12. The system of claim 10, wherein said computer-readable cellular application is configured to be downloadable from said server to a user mobile device, via a website.

13. The method of claim 9, wherein said WAP is selected from the group including: a wireless router and a wireless repeater.

14. A business method for providing access to a wireless signal in return for sending an SMS message, the method including the steps, by a server, of:
(a) registering a Wireless Access Point (WAP), said WAP having an Internet Protocol (IP) address;
(b) assigning a cell-phone number to said IP address;
(c) receiving a Short Message Service (SMS) request message, sent to said cell-phone number assigned to said IP address from a user mobile cellular device located in range of the wireless signal broadcast from said WAP, said SMS request message including a request for a limited access code to said wireless signal;
(d) sending an SMS code message, including a said limited access code, to said user mobile cellular device; and
(e) granting limited access to the wireless signal, to a mobile device that is providing a said limited access code to the server, when said mobile device is located in range of the wireless signal.

15. The business method of claim 14, wherein said WAP is managed by a WAP controller.

16. The business method of claim 15, wherein said WAP controller is compensated for broadcasting the wireless signal.

17. The business method of claim 16, wherein said compensation is a predetermined percentage of a cost of sending said SMS request message.

18. The business method of claim 14, wherein the server is managed by a managing entity selected from the group including: an Internet Service Provider (ISP) and a service center.

19. The business method of claim 18, wherein said managing entity receives a percentage of said cost of sending a said SMS request message.

20. The business method of claim 14, wherein an advertizing entity pays for said SMS request message.

21. The business method of claim 20, wherein said limited access includes advertizing information.
